(19) United States
(12) Patent Application Publication
(10) Pub. No.: US 2025/0183456 A1
(43) Pub. Date: Jun. 5, 2025

(54) BATTERY PACK

(71) Applicant: General Starlight Co. Inc., Woodbridge (CA)

(72) Inventor: Simon CHENDEROVITCH, Maple (CA)

(21) Appl. No.: 18/962,449

(22) Filed: Nov. 27, 2024

Related U.S. Application Data
(60) Provisional application No. 63/605,303, filed on Dec. 1, 2023.

(51) Int. Cl. H01M 50/262; H01M 50/213; H01M 50/24; H01M 50/247; H01M 50/296

(52) U.S. Cl. CPC H01M 50/262; H01M 50/213; H01M 50/24; H01M 50/247; H01M 50/296; H01M 2220/30

(57) ABSTRACT

Versatile battery packs are disclosed herein. In an embodiment, the battery pack includes a first chamber, a second chamber and a locking structure. The first battery chamber is configured to receive a first battery cartridge and has a first removable cover that when installed provides a watertight seal. The second battery chamber is configured to receive a second battery cartridge and has a second removable cover that when installed provides a watertight seal. The locking structure is located between the first battery chamber and the second battery chamber. The locking structure includes a release lever and an elongated space. The release lever includes a locking side protruding into the elongated space that enables a rail to translate into the elongated space in a first direction and prevents the rail from translating in an opposite second direction unless the release lever is manually actuated by a user.

### PRIORITY CLAIM

The present application claims priority to U.S. Provisional Patent Application No. 63/605,303, filed Dec. 1, 2023, entitled “Battery Pack,” the entire contents of which is incorporated herein by reference.

### BACKGROUND

### Technical Field

The present disclosure generally relates to battery pack. More specifically, the present disclosure relates to versatile battery pack that can quickly and easily attach to a variety of devices and provide differing voltages as needed.

### Background Information

Battery packs are used with various types of equipment. Typically, each piece of equipment has its own unique battery pack that can only be used with that particular piece of equipment.

### SUMMARY

The present disclosure provides a versatile battery pack configured to securely attach to a variety of devices, to enable a user to alternate between drawing power from two distinct battery cartridges as needed, and to simultaneously power multiple electronic devices requiring different voltages. The disclosed battery pack is convenient to use and does not require any proprietary or built-in batteries, for example, accepting standard AA batteries widely available anywhere in the world. The disclosed battery pack also has a waterproof housing and can be used as a universal powering tool for lengthy activities in remote locations where battery charging equipment is not accessible. The disclosed battery pack provides reliable and uninterrupted power to a wide variety of electronic and electro-optical systems, such as night vision, thermal vision, fusion vision or other electronic and electro-optical systems. The disclosed battery pack also houses a lever for quick attachment and removal from the device or accessory being powered, and has an equal weight distribution enabling it to act as a counterweight for the device it attaches to.

In an embodiment, the disclosed battery pack can be mounted on a firearm's picatinny rail to substantially increase operation time of a night vision, thermal, or fusion rifle scope without obstructing access to the main controls of the rifle. The excellent weight distribution of the battery pack also makes operation of the firearm just as comfortable as if the battery pack was not attached at all.

In view of the state of the known technology, one aspect of the present disclosure is to provide a battery pack having a first battery chamber, a second battery chamber and a locking structure. The first battery chamber is configured to receive a first battery cartridge and has a first removable cover that when installed provides a watertight seal. The second battery chamber is configured to receive a second battery cartridge and has a second removable cover that when installed provides a watertight seal. The locking structure is located between the first battery chamber and the second battery chamber. The locking structure includes a release lever movable between a locked position and an unlocked position and an elongated space configured to receive a rail. The locking structure is configured such that (i) when the release lever is in the locked position, the release lever protrudes into the elongated space to lock onto the rail, and (ii) when the release lever is in the unlocked position, the release lever retracts from the elongated space to disengage the rail.

A second aspect of the present disclosure is to provide a battery pack having a first chamber, a second chamber, a plurality of plug ports, a locking structure and a control switch. The first battery chamber is configured to receive a first battery cartridge and has a first removable cover that when installed provides a watertight seal. The second battery chamber is configured to receive a second battery cartridge and has a second removable cover that when installed provides a watertight seal. The plurality of plug ports are configured to electrically connect to batteries in the first battery cartridge and the second battery cartridge and supply power from the first battery cartridge and the second battery cartridge to a plurality of electrical devices in a plurality of differing voltage outputs. The locking structure is located between the first battery chamber and the second battery chamber and configured to lock onto a rail. The control switch is configured to alternate between: (i) an off position in which the plurality of plug ports do not supply the power in the plurality of differing voltage outputs from either of the first battery cartridge or the second battery cartridge, (ii) a first on position in which the plurality of plug ports supply the power in the plurality of differing voltage outputs from the first battery cartridge and not the second battery cartridge, and (iii) a second on position in which the plurality of plug ports supply the power in the plurality of differing voltage outputs from the second battery cartridge and not the first battery cartridge.

A third aspect of the present disclosure is to provide a battery pack assembly including an elongated rail and a battery pack. The elongated rail has a plurality of teeth. The battery pack includes a first battery chamber, a second battery chamber, a plurality of plug ports and a locking structure. The first battery chamber and the second battery chamber are each configured to receive a respective battery cartridge and have a respective removable cover that when installed provides a watertight seal. The plurality of plug ports are connected to the first battery cartridge and the second battery cartridge and configured to supply power from the first battery cartridge and the second battery cartridge to a plurality of electrical devices in a plurality of differing voltage outputs. The locking structure includes a release lever movable between a locked position and an unlocked position and an elongated space configured to receive the rail. The locking structure is configured such that (i) when the release lever is in the locked position, the release lever protrudes into the elongated space to lock onto the rail, and (ii) when the release lever is in the unlocked position, the release lever retracts from the elongated space to disengage the rail.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 is a front perspective view of an example embodiment of a battery pack assembly in accordance with the present disclosure;

FIG. 2 is a rear perspective view of the battery pack assembly including a battery pack and a rail;

FIG. 3 is an exploded front perspective view of the battery pack;

FIG. 4 is another exploded front perspective view of the battery pack;

FIG. 5 is a top plan view of the battery pack;

FIG. 6 is a cross-sectional view take across lines 6-6 in FIG. 5 which also shows the battery pack being locked to the rail;

FIG. 7 is a perspective view of the battery pack supplying power to a variety of electrically operated devices;

FIG. 8 is a perspective view of the battery pack mounted to a rifle and supplying power to an example electronic device;

FIG. 9 is another perspective view of the battery pack mounted to a helmet and supplying power to an electronic device; and

FIG. 10 is a yet another perspective view of the battery pack mounted and supplying power to an electronic device.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

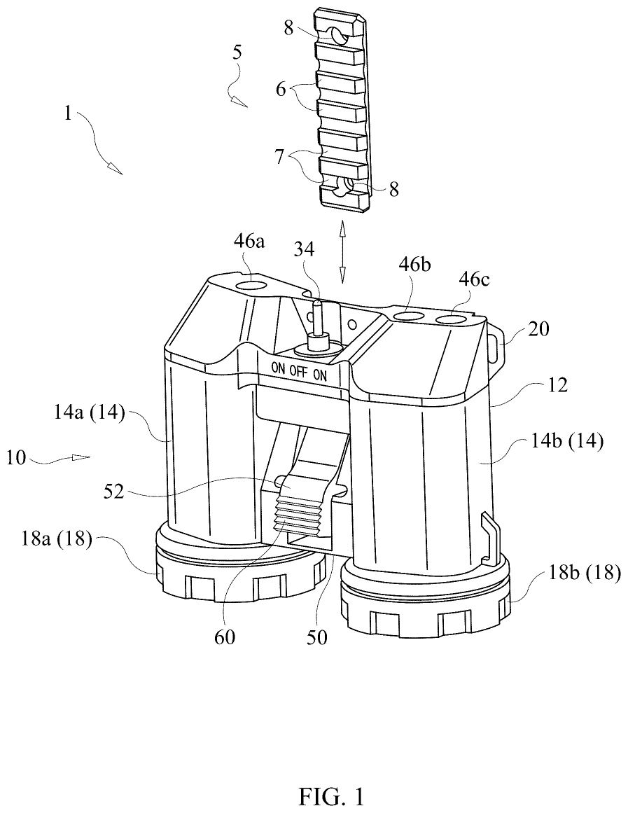

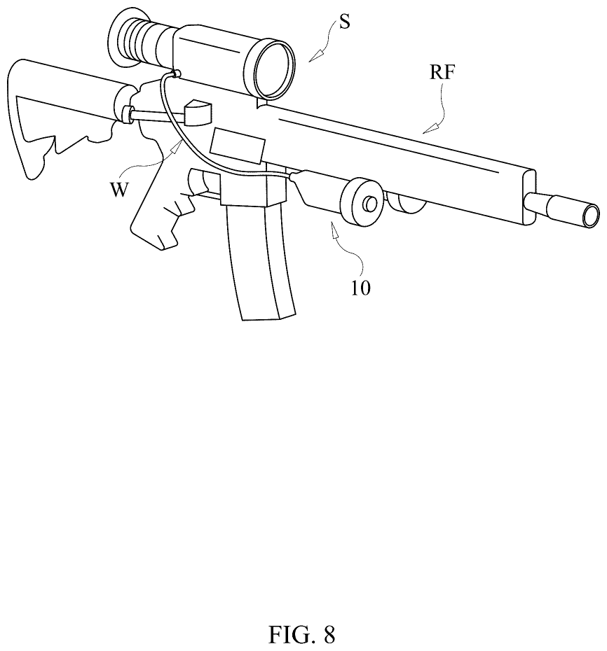

FIGS. 1 to 6 illustrate an example embodiment of a battery pack assembly 1 in accordance with the present disclosure. The battery pack assembly 1 includes an elongated rail 5 and a battery pack 10. In an embodiment, the elongated rail 5 is provided with the battery pack 10, such that the rail 5 can be attached to virtually any surface, and then the battery pack 10 can be locked onto the rail 5 and removed or repositioned as needed. Alternatively, the battery pack 10 can be locked onto a device that already includes a similar rail 5 as a part thereof. For example, the battery pack 10 can be mounted on a firearm's picatinny rail to power an attached night vision, thermal or fusion rifle scope, as seen for example in FIG. 8.

In the illustrated embodiment, the battery pack 10 generally includes a housing 12 having a pair of battery chambers 14 (a first battery chamber 14a and a second battery chamber 14b) configured to receive a pair of battery cartridges 16 (a first battery cartridge 16a and a second battery cartridge 16b). Here, each of the battery cartridges 16 is dimensioned to hold four AA batteries, although alternative embodiments of battery cartridges 16 can be made in alternate sizes and/or configured for alternate types and numbers of batteries such as alkaline batteries, NiMH batteries, rechargeable batteries, lithium batteries, and so on.

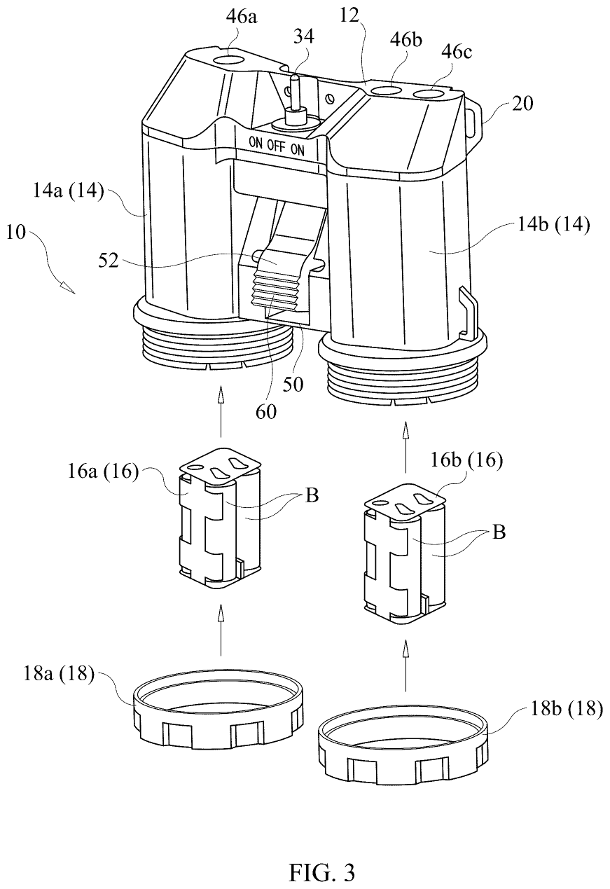

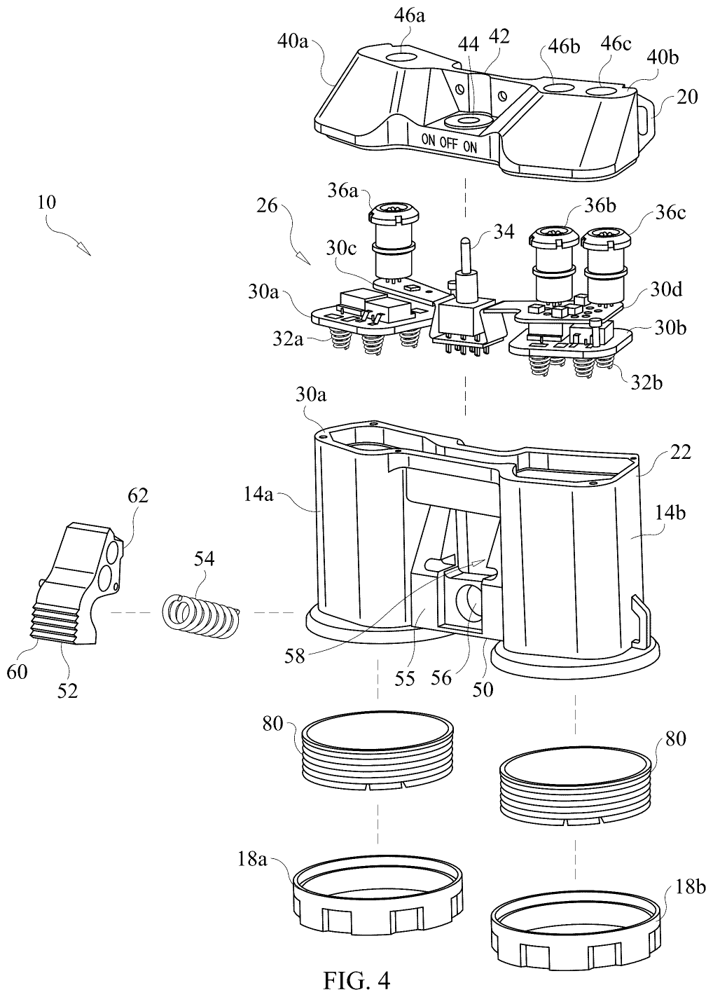

As seen in FIG. 3, each of the battery chambers 14 has a corresponding removable cover 18 that when installed secures a corresponding battery cartridge 16 within the battery chamber 14 and provides a watertight seal. That is, the first battery chamber 14a has a first removable cover 18a that when installed secures the first battery cartridge 16a and its batteries B within the first battery chamber 14a and provides a watertight seal, and the second battery chamber 14b has a second removable cover 18b that when installed secures the second battery cartridge 16b and its batteries B within the second battery chamber 14b and provides a watertight seal. As seen in FIG. 4, in the illustrated embodiment the removable covers 18 are attached at the open end of the battery chambers 14 by a threaded element 80, but alternative attachment mechanisms can also be used.

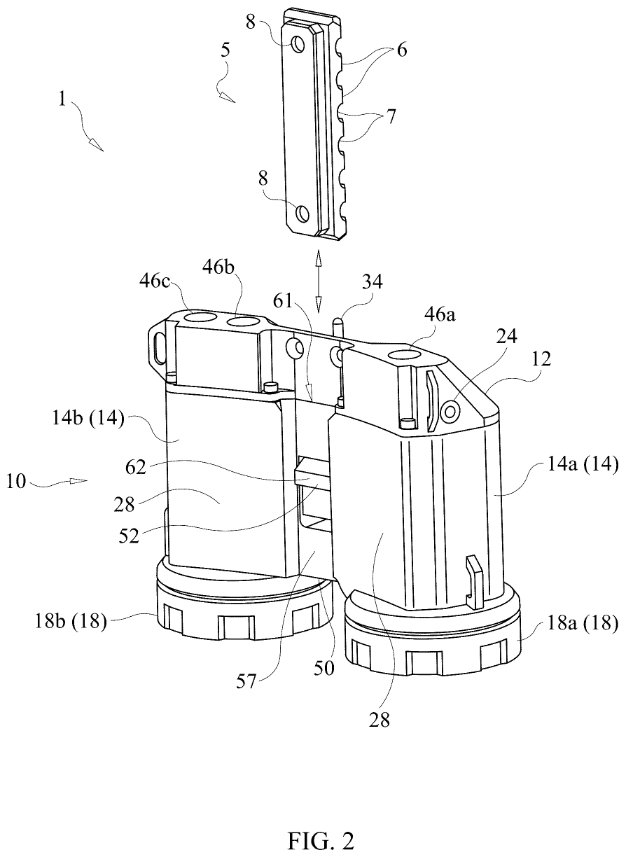

As best seen in FIG. 4, the housing 12 generally includes a first (e.g., upper) housing part 20 and a second (e.g., lower) housing part 22. The first housing part 20 can be attached to the second housing part 22 by screws, bolts, snap-fit or other mechanisms, as long as there is a watertight seal between the first housing part 20 and the second housing part 22. The first housing part 20 attaches to one side of the second housing part 22 in a watertight manner, and the removable covers 18 attach to the other side of the second housing part 22 in a watertight manner, creating a waterproof inner space for the battery cartridges 16 and the other circuitry located therein. As seen in FIG. 2, the top housing part 20 includes a purge screw 24. The purge screw 24 can be removed for a nitrogen purge, that is, for the air to be sucked out of the inner space of the housing 12 and replaced with nitrogen. The purge screw 24 can also be removed to pressure test the battery pack 10 to ensure that there are no leaks in any of the watertight seals.

As also seen in FIG. 4, the battery pack 10 includes control circuitry 26. Here, the control circuitry 26 includes one or more circuit board 30, a plurality of battery electrical contacts 32, a control switch 34 and a plurality of plug electrical contacts 36. The control circuitry 26 is positioned in the waterproof space between the first housing part 20 and the second housing part 22 and operatively connects the batteries B and/or battery cartridges 16 to a plurality of plug ports 46 as discussed below.

The circuit board 30 controls power distribution between the batteries B in the battery cartridges 16 and one or more electrical devices plugged into the plurality of plug ports 46. In the illustrated embodiment, the plurality of plug ports 46 includes a 12-volt port, a 5-volt port and a 3-volt port located on the upper surface of the first housing part 20. The circuit board 30 electrically connects the plurality of battery electrical contacts 32 and the plurality of plug electrical contacts 36 so that the appropriate combinations of the batteries B in the battery cartridges 16 supply the desired voltage to the plug ports 46 whether it be 12 volts, 5 volts, 3 volts, or otherwise, enabling the battery pack 10 to be used with different types of devices having different voltage requirements.

In the illustrated embodiment, the control circuitry 26 includes a first circuit board 30a, a second circuit board 30b, a third circuit board 30c and a fourth circuit board 30d. The first and third circuit boards 30a, 30c are operatively connected to the control switch 34 on one side, and the second and fourth circuit boards 30b, 30d are operatively connected to the control switch 34 on the other side. The first circuit board 30a and the second circuit board 30b each have or are operatively connected to a plurality of respective battery electrical contacts 32a, 32b on one side thereof which are configured to electrically connect to the batteries B in the battery cartridges 16 and to draw power from the batteries B. The third circuit board 30c and the fourth circuit board 30d have or are operatively connected to a plurality of plug electrical contacts 36a, 36b, 36c which are configured to appropriately distribute the power from the batteries B in the battery cartridges 16 to electronic devices plugged into one or more of the plug ports 46a, 46b, 46c. In the illustrated embodiment, the third circuit board 30c has or is operatively connected to the first plug electrical contact 36a, and the fourth circuit board 30d has or is operatively connected the second plug electrical contact 36b and the third plug electrical contact 36c. Here, the first plug electrical contact 36a is for a 12-volt device, the second plug electrical contact 36b is for a 3-volt device, and the third plug electrical contact 36c is for a 5-volt device. Those of ordinary skill in the art will further recognize from this disclosure that other configurations are possible.

In the illustrated embodiment, the plug electrical contacts 36 include a waterproof casing, which here is a column that extends from the circuit board(s) 30 to the respective plug ports 46. The waterproof casing is located within the inner space of the first housing part 22 when the first housing part 20 is attached to the second housing part 22. The waterproof casing can further include an o-ring or other waterproof feature that seals the casing against the respective port 46 and maintains the waterproof interior of the housing 12.

The control switch 34 is located in the center of the control circuitry 26. In the illustrated embodiment, the control switch 34 is operable between three positions: (1) an off position, (2) a first on position, and (3) a second on position. When the control switch 34 is in the off position, the control circuitry 26 does not draw power from the batteries B in either of the battery cartridges 16. When the control switch 34 is in the first on position, the control circuitry 26 draws power from the batteries B in the first battery cartridge 16a and not the second battery cartridge 16b. When the control switch 34 is in the second on position, the control circuitry 26 draws power from the batteries B in the second battery cartridge 16b and not the first battery cartridge 16a. The control switch 34 can therefore be used to switch over to one battery cartridge 16a, 16b when the other battery cartridge 16a, 16b runs out of power to keep the battery pack 10 operable, which is advantageous in locations where battery charging or powering equipment is not accessible. In the illustrated embodiment, the control switch 34 is in a vertical centered position as the off position. The control switch 34 is flipped towards the first battery chambers 14a to be placed in the first on position and towards the second battery chamber 14b to be placed in the second on position.

In the illustrated embodiment, the first housing part 20 includes a first side portion 40a, a second side portion 40b and middle portion 42. The first side portion 40a houses the first and third circuit boards 30a, 30c and the first plug electrical contact 36a. The second side portion 40b houses the second and fourth circuit boards 30b, 30d and the second and third plug electrical contacts 36b, 36c. The middle portion 42 includes a control aperture 44 configured to receive the control switch 34 therethrough and place a watertight seal around the control switch 34. The relative positioning of these elements within the first housing part 20 minimizes the dimensions of the battery pack and enables equal weight distribution.

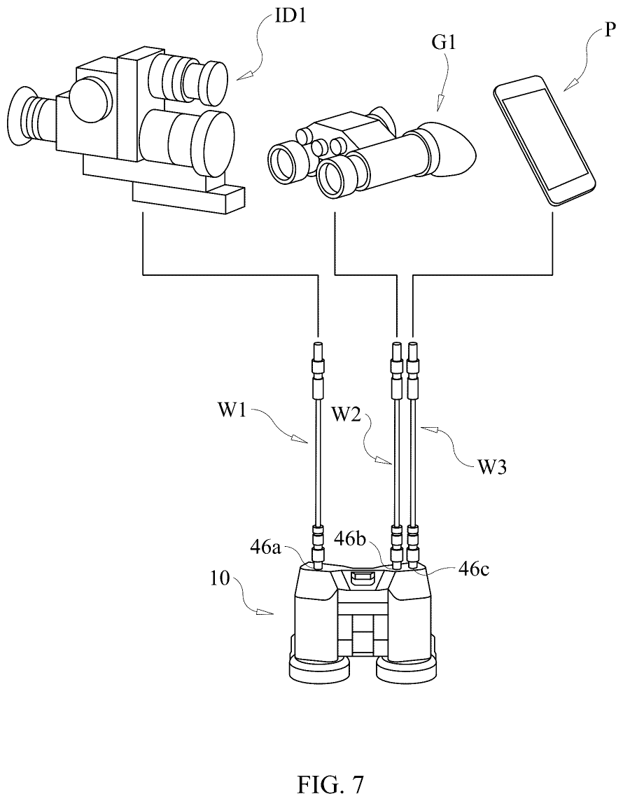

The first housing 20 further includes the plug ports 46 electrically connected to respective plug electrical contacts 36. The plug ports 46 are configured to receive electrical plugs corresponding to electrical devices requiring varying voltages. As seen for example in FIG. 7, each of the plug ports 46 is configured to receive an electrical device plug and electrically connect the corresponding electrical device to a respective electrical contact 36 to provide power to the respective electrical device. Here, the first housing portion 40a includes a first plug port 46a that connects a 12-volt electrical device to the first plug electrical contact 36a, and the second housing portion 40b includes a second plug port 46b that connects a 3-volt electrical device to the second plug electrical contact 36b and a third plug port 46c that connects a 5-volt electrical device to the third plug electrical contact 36c.

In the illustrated embodiment, the second housing part 22 forms the battery chambers 14. The second housing part 22 also includes a locking structure 50 configured to attach to the rail 5. The locking structure 50 is located in the middle of the second housing part 22 between the first battery chamber 14a and the second battery chamber 14b. This symmetrical and balanced design enables the battery pack 10 to serve a counterweight for the devices it attaches to. The battery pack 10 can also attach to devices in other ways besides using the locking structure 50 and a corresponding rail 5. For example, the rear surfaces 28 of the battery chambers 14 are generally flat and can be configured to attach to device such as a helmet, for example, using adhesives or hook and loop material.

In the illustrated embodiment, the elongated rail 5 is a picatinny rail. The rail 5 can also be other types of rails such as a weaver rail or otherwise. The illustrated rail 5 includes a plurality of teeth 6 with spaces 7 therebetween. The rail 5 further includes one or more apertures 8 that are perpendicular to the longitudinal length thereof, enabling bolts or screws to be attached therethrough to secure the rail 5 to a variety of surfaces.

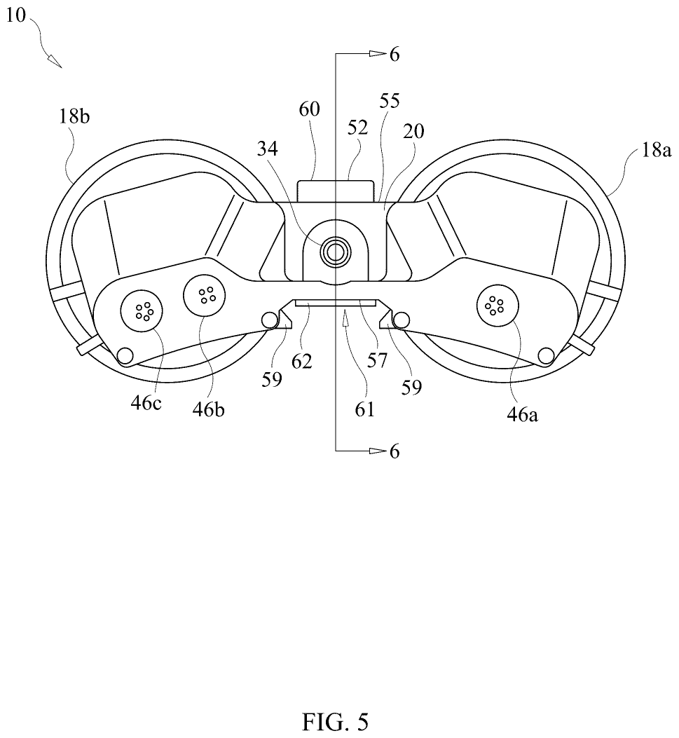

In the illustrated embodiment, the locking structure 50 includes a release lever 52 and a biasing mechanism 54. As seen in FIG. 4, the release lever 52 and the biasing mechanism 54 can be detachable parts that are attached to the second housing part 22 between the first battery chamber 14a and the second battery chamber 14b. As for portions of the locking structure 50 formed by the second housing part 22, the locking structure 50 has a front side 55 having an indentation 56 therein, a rear side 57 opposite the front side 56, and an aperture 58 that passes through the housing 12 from the front side 55 to the rear side 57. As seen in FIG. 5, the rear side 57 further includes two protrusions 59 that protrude inwardly and that together form an elongated space 61 for the rail 5 when the battery pack 10 is slid onto the rail 5.

The release lever 52 includes an actuator side 60 and a locking side 62. As seen in FIGS. 4 and 5, the release lever 52 is located within the indentation 56 and through the aperture 58 such that the actuating side 60 of the release lever 52 protrudes outward from the front side 55 of the locking structure 50 and the locking side 62 of the release lever 52 protrudes outward from the rear side 57 of the locking structure 50 and into the elongated space 61. A user actuates the actuating side 60 on the front side 55 to withdraw/release the locking side 60 from the rail 5 on the rear side 57.

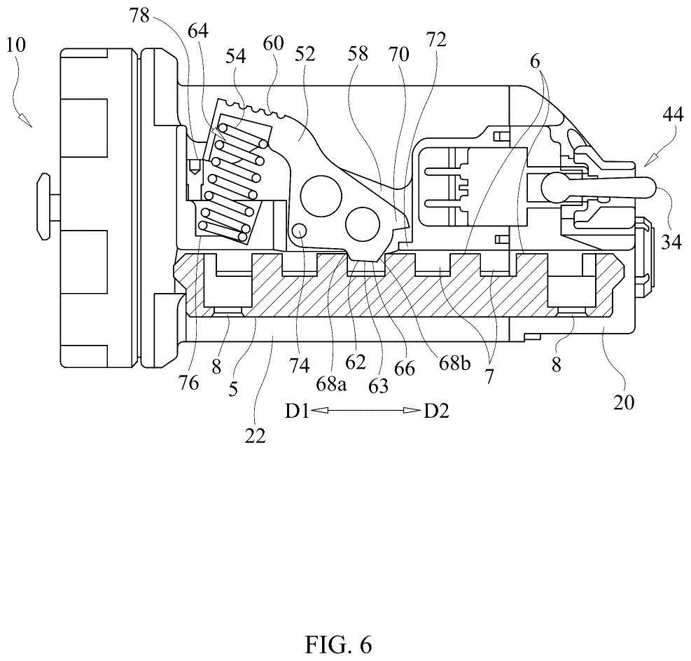

FIG. 6 illustrates the locking structure 50 in more detail. As seen in FIG. 6, on one side of the release lever 52, the locking side 62 includes a locking tooth 63. On the other side of the release lever 52, the actuator side 60 includes an indentation 64 that receives the biasing mechanism 54. The biasing mechanism 54 is located between the indentation 56 in the second housing part 22 and the indentation 64 in the release lever 52. The biasing mechanism 54 biases the actuator side 60 of the release lever 52 outward from the front side 55 of the locking structure 50. Here, the biasing mechanism 54 is a spring, but other biasing mechanisms can also be used.

As further seen in FIG. 6, the locking tooth 63 includes a generally flat center surface 66 between two angled side surfaces 68a, 68b. The release lever 52 further includes a projecting surface 70 located within the aperture 58 and configured to contact a corresponding stopper surface 72 on an inner portion of the aperture 58. The release lever 52 is pivotally attached to the second housing part 22 at a pivot point 74. The biasing mechanism 54 is placed in tension between an inner surface 76 of the indentation 56 and an opposite surface of the release lever 52 within the indentation 64, thus biasing the release lever 52 around the pivot point 74 (clockwise in FIG. 6) until the locking tooth 62 contacts the rail 5 or the projecting surface 70 contacts the stopper surface 72.

In use, the battery pack 10 is translated over the rail 5 in the direction of the longitudinal length of the rail 5, so that the rail 5 enters the elongated space 61. Typically, the user actuates the release lever 52 (here, by pressing the actuator side 60 inward against the biasing force of the biasing mechanism 54) to cause the locking tooth 63 to withdraw from the elongated space 61. The user then slides the battery pack 10 over the rail 5 so that the rail 5 enters the elongated space 61. When the battery pack 10 is located in the desired position along the rail 5, the user releases the release lever 52, causing the biasing force of the biasing mechanism 54 to push the locking tooth 63 into a rail space 7 to prevent the battery pack 10 from translating further. To remove the battery pack 10 from the rail 5, the user actuates the release lever 52 (here, by again pressing the actuator side 60 inward against the biasing force of the biasing mechanism 54) to cause the locking tooth 63 to withdraw from the rail space 7 so that the battery pack 10 can slide off of the rail 5 in either direction. In the illustrated embodiment, the battery pack 10 can include one or more screws 78 to prop the release lever 52 into the locked position, for example, to prevent the battery pack 10 from self-releasing when attached to a rifle due to rifle recoil.

In the illustrated embodiment, the locking tooth 63 is dimensioned so that the battery pack 10 can also be translated over the rail 5 in the direction D1 without actuating the release lever 52, and so that the locking tooth 63 prevents the battery pack 10 from translating in the opposite direction D2 unless a user manually actuates the release lever 52. That is, when the battery pack 10 is translated in the direction D1 over the rail 5, each tooth 7 of the rail 5 strikes one side surface 68a to push the locking tooth 63 out of the elongated space 61 and into the aperture 58 toward the front side 55 of the locking mechanism 50, causing the release lever 52 to pivot against the biasing force of the biasing mechanism 54 (counterclockwise in FIG. 6). The biasing force then pushes the locking tooth 63 back into the adjacent rail space 7 so that the other side surface 68b prevents the battery pack 10 from translating in the opposite direction D2. To remove the battery pack 10 from the rail 5, a user actuates the release lever 52 (here, by pressing the actuator side 60 inward against the biasing force of the biasing mechanism 54) to cause the locking tooth 63 to withdraw from the respective space 7 so that the battery pack 10 can be detached from the rail 5 by translating with respect to the rail 5 in the direction D2.

Thus, in the illustrated embodiment, the locking mechanism 50 permits the battery pack 10 to slide over the rail 5 in the direction D1 whether or not the release lever 52 is actuated, but prevents the battery pack 10 from sliding over the rail 5 in the opposite direction D2 unless the release lever 52 is actuated by the user. Even still, the user can actuate the lever 52 when moving the battery pack 10 over the rail in the direction D1, for example, for smoother translation or to prevent grinding or accidental skipping through teeth 6 of the rail 5.

FIGS. 7 to 10 illustrate example embodiments of how the battery pack 10 can be used with a variety of electrical devices in remote locations where battery supply and/or charging equipment is not accessible.

FIG. 7 illustrates an example embodiment of the battery pack 10 simultaneously providing power to a variety of devices. Here, an imaging device ID1 is attached to the 12-volt port 46a by a first wire W1, a pair of goggles G1 is attached to the 3-volt port 46b by a second wire W2, and a phone P is attached to the 5-volt port 46c by a third wire W3.

FIG. 8 illustrates an example embodiment of the battery pack 10 attached/locked to a rifle RF and providing power to a rifle scope S via a wire W. The scope S can be, for example, a night vision, thermal or fusion rifle scope. Such scopes S require power that can be provided by the battery pack 10. The rifle RF can have its own rail 5, or a rail 5 provided with the battery pack 10 can be secured to the rifle RF and then the battery pack 10 can be locked onto the rail 5. Many rifles already include a picatinny rail that can be used to attach the battery pack 10 to the underside of the barrel of the rifle RF. The symmetry and weight distribution of the battery pack 10 also makes operation of the rifle R just as comfortable as if the battery pack 10 was not attached at all.

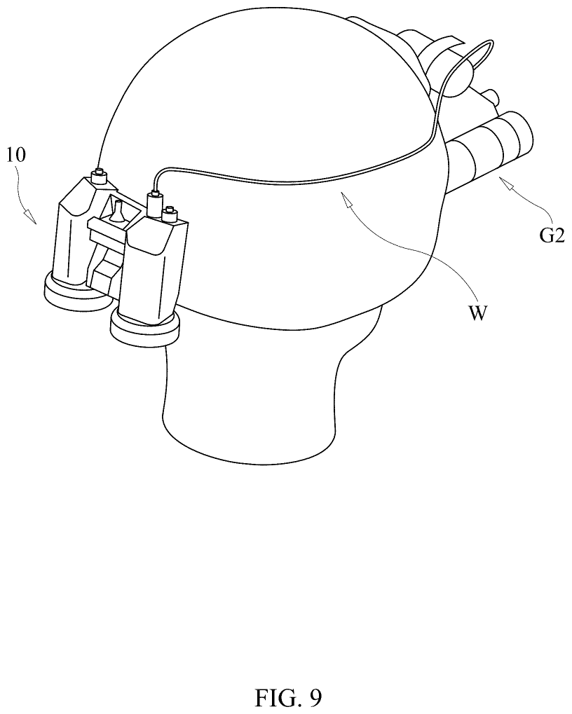

FIG. 9 illustrates an example embodiment of the battery pack 10 attached to the back of a helmet H and providing power to goggles G2 via a wire W. Here, the googles G2 are night vision goggles that require electrical power. In one embodiment, the rail 5 is attached to the back of the helmet H, and the battery pack 10 is then locked to the rail 5. The helmet H can have its own rail 5, or a rail 5 provided with the battery pack 10 can be secured to the helmet H and then the battery pack 10 can be locked to the rail 5. In an alternative embodiment, the rear surfaces 28 of the battery chambers 14 can include an adhesive, hook and loop material, or another mechanism that attaches the battery pack 10 to the helmet H.

In FIG. 9, the attachment of the battery pack 10 to the rear of the helmet H provides a balancing force. That is, the night vision goggles G2 are attached to the front of the helmet H, and the battery pack 10 is attached to the rear of the helmet H approximately balancing the weight of the goggles G. The person wearing the helmet H does not feel the force of the goggles G2 pulling the front of the helmet H down because the battery pack 10 provides a counterweight or countering force. In other words, the helmet H is more comfortable to wear with the battery pack 10 being located opposite (rearward of) the goggles G. The battery pack 10 thus supplies power to the goggles G while being a counterweight at the same time.

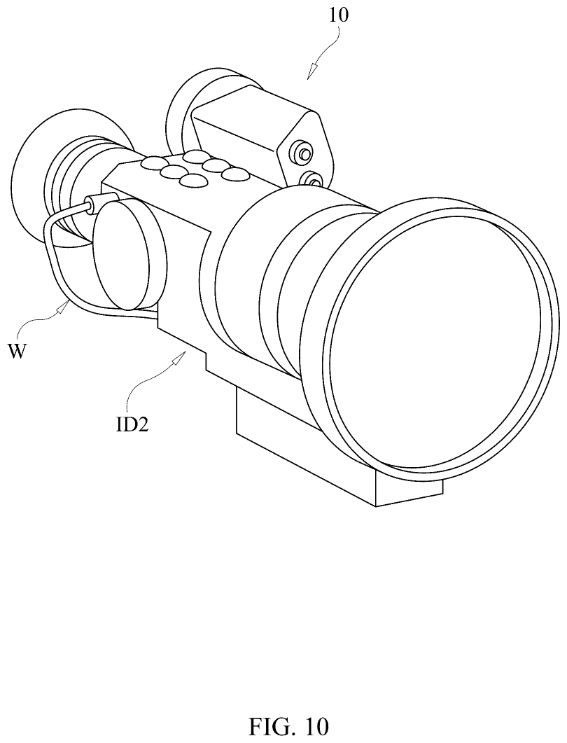

FIG. 10 illustrates an example embodiment of the battery pack 10 attached to an imaging device ID2 vial a rail 5 and providing power via a wire W. The imaging device ID2 can have its own rail 5, or a rail 5 provided with the battery pack 10 can be secured to the imaging device ID2 and then the battery pack 10 can be locked to the rail 5. Here, the imaging device ID2 is an electro-optical device (here, a monocular device) requiring power and having its own picatinny rail, so that the battery pack 10 easily and directly attaches thereto and then provides power in the voltage needed through one of the plurality of plug ports 46.

The embodiments described herein provide improved battery packs that are versatile and can be used in remote locations. These battery packs are advantageous, for example, because they can adjustably attach/lock to a variety of devices, can provide power in a plurality of different voltages, and can be utilized as a counterweight for the devices they attach to. It should be understood that various changes and modifications to the systems and methods described herein will be apparent to those skilled in the art and can be made without diminishing the intended advantages.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment the following directional terms “forward”, “rearward”, “above”, “downward”, “vertical”, “horizontal”, “below” and “transverse” as well as any other similar directional terms can be used relatively to refer to a battery pack and/or to a device equipped with the battery pack.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A battery pack comprising:
a first battery chamber configured to receive a first battery cartridge and having a first removable cover that when installed provides a watertight seal;
a second battery chamber configured to receive a second battery cartridge and having a second removable cover that when installed provides a watertight seal; and
a locking structure located between the first battery chamber and the second battery chamber, the locking structure including a release lever movable between a locked position and an unlocked position and an elongated space configured to receive a rail, the locking structure configured such that (i) when the release lever is in the locked position, the release lever protrudes into the elongated space to lock onto the rail, and (ii) when the release lever is in the unlocked position, the release lever retracts from the elongated space to disengage the rail.

2. The battery pack of claim 1, wherein
the rail includes a plurality of teeth, and
the release lever protrudes into spaces between the teeth to prevent the rail from translating in the opposite second direction.

3. The battery pack of claim 2, wherein
the locking structure enables the battery pack to translate over the rail in a first direction without the release lever being manually actuated by a user, and prevents the battery pack from translating over the rail in an opposite second direction unless the release lever is manually actuated by the user.

4. The battery pack of claim 1, comprising
a housing forming the first battery chamber and the second battery chamber and including an aperture between the first battery chamber and the second battery chamber,
the elongated space located on a first side of the aperture, and
the release lever extending through the aperture with a locking side extending from the first side into the elongated space for the rail.

5. The battery pack of claim 4, wherein
the release lever includes an actuating side protruding from a second side opposite side opposite the first side.

6. The battery pack of claim 1, wherein
the release lever is configured to pivot with respect to the first chamber and the second chamber.

7. The battery pack of claim 1, wherein
the locking structure includes a biasing mechanism configured to bias a locking side of the release lever into the locked position in which the locking side protrudes between teeth of the rail.

8. The battery pack of claim 1, comprising
a plurality of plug ports and a control switch configured to alternate between a first on position and a second on position,
the plurality of plug ports supplying power from the first battery cartridge and not the second battery cartridge when the control switch is in the first on position, and
the plurality of plug ports supplying power from the second battery cartridge and not the first battery cartridge when the control switch is in the second on position.

9. The battery pack of claim 1, comprising
a plurality of plug ports configured to electrically connect to the first battery cartridge and the second battery cartridge and supply power from the first battery cartridge and the second battery cartridge to a plurality of electrical devices in a plurality of differing voltage outputs.

10. A battery pack comprising:
a first battery chamber configured to receive a first battery cartridge and having a first removable cover that when installed provides a watertight seal;
a second battery chamber configured to receive a second battery cartridge and having a second removable cover that when installed provides a watertight seal;
a plurality of plug ports configured to electrically connect to batteries in the first battery cartridge and the second battery cartridge and supply power from the first battery cartridge and the second battery cartridge to a plurality of electrical devices in a plurality of differing voltage outputs;
a locking structure located between the first battery chamber and the second battery chamber and configured to lock onto a rail; and
a control switch configured to alternate between: (i) an off position in which the plurality of plug ports do not supply the power in the plurality of differing voltage outputs from either of the first battery cartridge or the second battery cartridge, (ii) a first on position in which the plurality of plug ports supply the power in the plurality of differing voltage outputs from batteries in the first battery cartridge and not the second battery cartridge, and (iii) a second on position in which the plurality of plug ports supply the power in the plurality of differing voltage outputs from batteries in the second battery cartridge and not the first battery cartridge.

11. The battery pack of claim 10, wherein
the locking structure includes a release lever movable between a locked position and an unlocked position and an elongated space configured to receive the rail,. the locking structure configured such that (i) when the release lever is in the locked position, the release lever protrudes into the elongated space to lock onto the rail, and (ii) when the release lever is in the unlocked position, the release lever retracts from the elongated space to disengage the rail.

12. The battery pack of claim 11, comprising
a housing forming the first battery chamber and the second battery chamber and including an aperture between the first chamber and the second chamber,
the elongated space located on a first side of the aperture, and
the release lever extending through the aperture with a locking side extending from the first side into the elongated space for the rail.

13. The battery pack of claim 11, wherein
the plurality of plug ports includes at least two of a 12-volt port, a 5-volt port and a 3-volt port.

14. The battery pack of claim 11, wherein
the housing includes a first housing part and a second housing part which are attached to form a watertight space therein,
the first housing part including the plurality of ports, and
the second housing part includes the first battery chamber, the second battery chamber and the locking structure.

15. A battery pack assembly comprising:
a rail having a plurality of teeth; and
a battery pack including
a first battery chamber and a second battery chamber each configured to receive a respective battery cartridge and having a respective removable cover that when installed provides a watertight seal,
a plurality of plug ports electrically connected to the first battery cartridge and the second battery cartridge and configured to supply power from the first battery cartridge and the second battery cartridge to a plurality of electrical devices in a plurality of differing voltage outputs, and
a locking structure including a release lever movable between a locked position and an unlocked position and an elongated space configured to receive the rail, the locking structure configured such that (i) when the release lever is in the locked position, the release lever protrudes into the elongated space to lock onto the rail, and (ii) when the release lever is in the unlocked position, the release lever retracts from the elongated space to disengage the rail.

16. The battery pack of claim 15, wherein
the locking structure enables the battery pack to translate over the rail in a first direction without the release lever being manually actuated by a user, and prevents the battery pack from translating over the rail in an opposite second direction unless the release lever is manually actuated by the user.

17. The battery pack of claim 15, wherein
the release lever includes a locking side protruding into the elongated space that retracts from the elongated space when the release lever is manually actuated by the user.

18. The battery pack of claim 15, wherein
the battery pack includes a control switch configured to alternate between: (i) an off position in which the plurality of plug ports do not supply the power in the plurality of differing voltage outputs from either of the first battery cartridge or the second battery cartridge, (ii) a first on position in which the plurality of plug ports supply the power in the plurality of differing voltage outputs from the first battery cartridge and not the second battery cartridge, and (iii) a second on position in which the plurality of plug ports supply the power in the plurality of differing voltage outputs from the second battery cartridge and not the first battery cartridge.

19. The battery pack of claim 15, wherein
the battery pack includes a housing having a first housing part and a second housing part which are attached to form a watertight space therein,
the first housing part including the plurality of plug ports,
the second housing part including the first battery chamber, the second battery chamber and the locking structure.

20. The battery pack of claim 19, wherein
the battery pack houses control circuitry within a watertight space created between the first housing part and the second housing part, and
the first housing part includes a purge screw enabling the battery pack housing to be pressure tested to ensure there are no leaks in the watertight space.
